(19) United States
(12) Patent Application Publication
(10) Pub. No.: US 2006/0049238 A1
(43) Pub. Date: Mar. 9, 2006

(54) Solderable structures and methods for soldering

(76) Inventors: Seong Choon Lim, Penang (MY); See Ling Chang, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/934,815

(22) Filed: Sep. 3, 2004

(51) Int. Cl. B23K 31/02

(52) U.S. Cl. 228/215

(57) ABSTRACT

A process for soldering a pad on a first substrate to a pad on a second substrate comprises: Coating the first substrate with a solder mask having a first thickness so that the solder mask leaves exposed the pad on the first substrate; coating the second substrate with a solder mask having a second thickness so that the solder mask leaves exposed the pad on the second substrate, the first and second thicknesses of the solder masks being selected so that the solder masks on the first and second substrates contact one another and define a solder mask wall when the first and second substrates are positioned adjacent one another so that the pads are substantially aligned; providing solder to at least one of the pads; placing the first and second substrates adjacent one another so that the pads are substantially aligned; and reflowing the solder to join the pads, the solder mask wall preventing liquid solder from flowing beyond the solder mask wall.

### BACKGROUND

A wide range of soldering processes and devices are known and are currently being used in a wide range of applications to solder together two or more metallic components. In the electronics industry, soldering processes have been developed that are useful in soldering electronic components and devices to printed circuit boards. Still other soldering processes have been developed that are specifically adapted to solder together pads provided on two substrates. By way of example, the two substrates may comprise a rigid printed circuit board and a flexible printed circuit board. In a common implementation, the rigid printed circuit board is provided with one or more pads which represent the circuit nodes that are desired to be electrically connected to the flexible printed circuit board. The flexible printed circuit board is provided with corresponding pads that are configured to align with the pads provided on the rigid printed circuit board. Thus, when the pads of the two substrates are soldered together, the desired circuit nodes of the rigid printed circuit board will be electrically and mechanically connected to the various traces provided on the flexible printed circuit board.

Several different types of soldering processes have been developed to solder the pads provided on the two substrates (e.g., the rigid printed circuit board and the flexible printed circuit board). One type of process is commonly referred to as “hot bar soldering.” Briefly, hot bar soldering involves a process wherein a heated bar or thermode is used to melt or re-flow solder provided on the pads that are to be soldered togther. In a typical hot bar soldering process, solder is first provided to the pads on the two substrates. The two substrates are then positioned adjacent one another so that the pads are aligned and generally in contact with one another. The heated bar is then brought into contact with the back side of one of the substrates (typically the flexible printed circuit board), whereupon heat from the hot bar is conducted through the substrate and to the solder. After sufficient heat has been applied, the solder previously provided to the pads melts, thereby soldering together the pads of the two substrates.

While the hot bar soldering process described above has been used for years to solder together pads provided on two different substrates, such as rigid and flexible printed circuit boards, it is not without its problems. For example, one problem relates to bridging of solder between adjacent pads, creating short circuits. While such bridging can be detected during the production process, it has proven difficult to repair. For example, it is difficult to un-solder (i.e., separate) the two substrates without causing damage to one or both of the substrates. While such solder bridging can be minimized or eliminated by ensuring sufficient spacing between the solder pads provided on the substrates, it is not always desirable, or even possible, to do so, particularly in light of the increasing miniaturization of electronic components and devices.

### SUMMARY OF THE INVENTION

A process for soldering a pad on a first substrate to a pad on a second substrate may comprise: Coating the first substrate with a solder mask having a first thickness so that the solder mask leaves exposed the pad on the first substrate; coating the second substrate with a solder mask having a second thickness so that the solder mask leaves exposed the pad on the second substrate, the first and second thicknesses of the solder masks being selected so that the solder masks on the first and second substrates contact one another and define a solder mask wall when the first and second substrates are positioned adjacent one another so that the pads are substantially aligned; providing solder to at least one of the pads; placing the first and second substrates adjacent one another so that the pads are substantially aligned; and reflowing the solder to join the pads, the solder mask wall preventing liquid solder from flowing beyond the solder mask wall.

Also disclosed is a first substrate having at least one pad thereon and a solder mask layer deposited on the first substrate so that the at least one pad on the first substrate is exposed by the solder mask layer. A second substrate has at least one pad thereon and a solder mask layer deposited on the second substrate so that the at least one pad on the second substrate is exposed by the solder mask layer.

### BRIEF DESCRIPTION OF THE DRAWINGS

Illustrative and presently preferred exemplary embodiments of the invention are shown in the drawings in which:

FIG. 1 is a plan view of a portion of a first substrate having a plurality of pads provided thereon as well as a solder mask layer;

FIG. 2 is a plan view of a portion of a second substrate having a plurality of pads provided thereon as well as a solder mask layer;

FIG. 3 is a cross-sectional view in elevation of portions of the first and second substrates positioned adjacent one another in preparation for soldering; and

FIG. 4 is a cross-sectional view in elevation of portions of the first and second substrates after soldering.

### DETAILED DESCRIPTION OF THE PREFERRED EMBODIMENTS

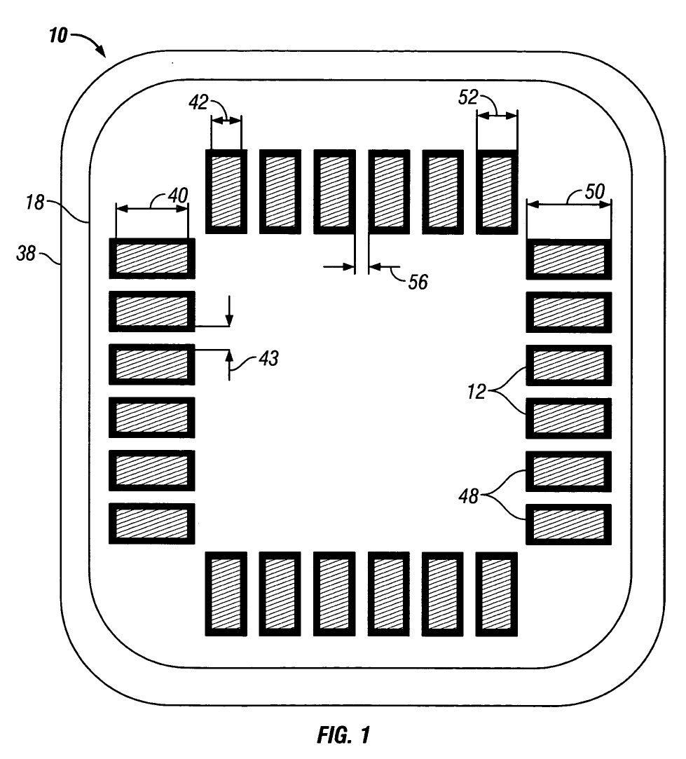

Solderable structures and methods for soldering according to the present invention are best understood by reference to FIGS. 1-4. A first substrate 10 may comprise at least one, and typically a plurality of pads 12 provided thereon. In one example embodiment, the pads 12 provided on first substrate 10 are circuit nodes that are to be electrically connected to corresponding pads 14 provided on a second substrate 16. The first substrate 10 may comprise a rigid printed circuit board (PCB) 38 of conventional construction, whereas the second substrate 16 may comprise a flexible printed circuit board (FCB) 58 also of conventional construction. Alternatively, the first and second substrates 10 and 16 may comprise other types of materials, as will be described in further detail below.

A solder mask layer 18 having a first thickness 20 is deposited on the first substrate 10 so that the solder mask layer 18 leaves exposed the pads 12 provided on the first substrate 10. Similarly, a solder mask layer 22 having a second thickness 24 is deposited on the second substrate 16 so that the solder mask layer 22 leaves exposed the pads 14 provided on the second substrate 16. The first and second thicknesses 20 and 24 of the solder mask layers 18 and 22 deposited on the corresponding first and second substrates 10 and 16 are selected so that the solder mask layers 18 and 22 contact one another and define a solder mask wall 26 when the first and second substrates 10 and 16 are positioned adjacent one another so that the respective pads 12 and 14 provided thereon are in the desired alignment. See FIG. 4.

Before the pads 12 and 14 on the respective first and second substrates 10 and 16 can be soldered together, solder 28 is provided to either one or both of the pads 12 and 14 provided on the first and second substrates 10 and 16. For example, in the embodiment shown and described herein, solder 28 is provided to the pads 14 provided on the second substrate 16. As will be described in greater detail below, the amount of solder 28 provided to the pads (e.g., pads 14) should not exceed the volume of an enclosed solder well 30 defined by the solder mask wall 26 when the first and second substrates 10 and 16 are positioned in contact with one another. See FIG. 4. It is also generally preferred that the solder 28 be provided in a thickness 32 so that the sum of the thickness 32 of the solder 28 and the respective thicknesses 34 and 36 of pads 12 and 14 exceeds the sum of the first and second thicknesses 20 and 24 of the respective solder mask layers 18 and 22. So selecting the thicknesses will allow the solder 28 provided to the pads (e.g., pads 14) to contact the corresponding mating pads (e.g., pads 12) before the solder mask layers 18 and 22 contact one another, thereby ensuring positive bonding between the solder 28 and the pads 12 and 14.

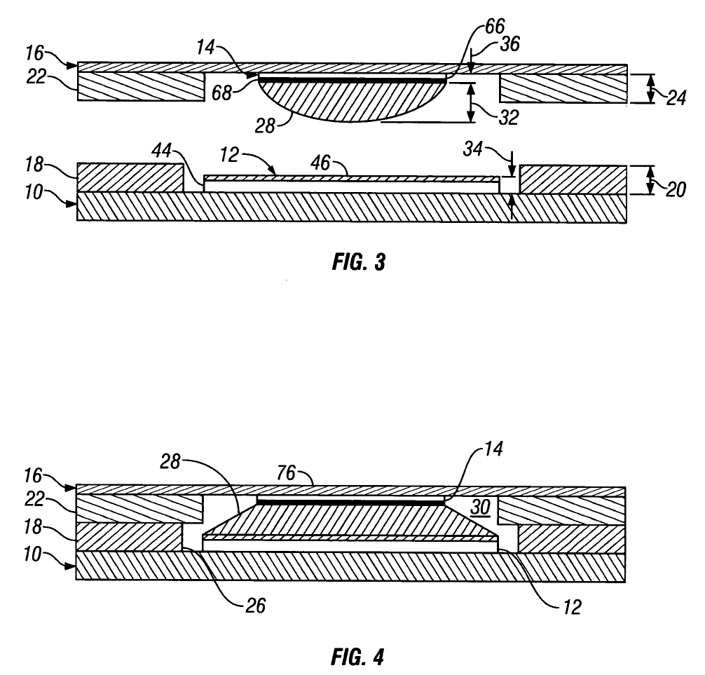

After the appropriate amount of solder 28 has been provided to the pads (e.g., pads 14), the two substrates 10 and 16 are positioned adjacent one another so that the pads 12 and 14 provided thereon are in the desired alignment. See FIG. 3. Further moving together the two substrates 10 and 16 will cause the solder 28 provided on pads 14 to contact the corresponding pads 12. The solder 28 may then be re-flowed (e.g., melted) by appropriate soldering apparatus, such as a hot bar soldering apparatus (not shown). The solder mask wall 26 formed by the contacting abutment of the solder mask layers 18 and 22 prevents liquid solder from flowing beyond the solder mask wall 26.

A significant advantage of the present invention is that it allows solder pads on two adjacent substrates to be soldered together while substantially reducing the likelihood of solder bridging between adjacent pads. The present invention therefore will allow for a reduction in the spacing or pitch provided between adjacent pads compared with the spacing commonly utilized with conventional soldering processes and solderable structures. Another significant advantage of the present invention is that the solder mask wall defined by the solder mask layers provided on the first and second substrates allows an appropriate volume of solder to be applied to the pads, thereby reducing the number of bad solder joints during production and increasing the reliability of the good solder joints. The methods and apparatus of the present invention are also readily adaptable to existing processing techniques and materials, thereby allowing for high production yields with currently available manufacturing apparatus and methods.

Having briefly described the soldering method and solderable structure of the present invention, as well as some of their more significant features and advantages, various exemplary embodiments of the soldering methods and solderable structures will now be described in detail. However, before proceeding with the description, it should be noted that the various exemplary methods and structures are shown and described herein as they could be utilized in embodiments involving the joining of one or more pads provided on a rigid printed circuit board to corresponding pads provided on a flexible printed circuit board. However, other embodiments and variations are possible, some of which will be described in further detail below, others of which would become apparent to persons having ordinary skill in the art after having become familiar with the teachings provided herein. Therefore, the methods and structures of the present invention should not be regarded as limited to the particular embodiments and applications shown and described herein.

Referring now primarily to FIGS. 1 and 3, a first substrate 10 of a solderable structure that may be provided in accordance with the teachings of the present invention may comprise at least one, and typically a plurality, of solder pads 12 provided thereon. The first substrate 10 may comprise any of a wide variety of substrates (e.g., rigid or flexible) now known in the art or that may be developed in the future having one or more pads 12 provided thereon. Consequently, the present invention should not be regarded as limited to a first substrate 10 having any particular structure or made from any particular material. However, by way of example, in one embodiment, the first substrate 10 comprises a multi-layered, rigid printed circuit board (PCB) 38 of conventional (e.g., epoxy-glass) construction. In addition, because the first substrate 10 could comprise any of a wide range of substrates and because a detailed description of the particular structure and materials that may comprise the first substrate 10 is not necessary to practice the present invention, the particular substrate 10 that may be utilized in one embodiment of the present invention will not be described in further detail herein.

Referring now primarily to FIG. 1, the various solder pads 12 provided on the first substrate 10 may be electrically connected to circuit traces or nodes (not shown) provided on or within the first substrate 10 by conventional means. The particular configuration and dimensions of the solder pads 12 provided on the first substrate 10 are not particularly critical, and the pads 12 and may comprise any of a wide range of configurations (e.g., square, rectangular, circular, etc.) having any of a wide range of dimensions, depending on the particular application. Consequently, the present invention should not be regarded as limited to pads 12 having any particular configuration. However, by way of example, in one embodiment, each pad 12 comprises a generally rectangular configuration having a length 40 of about 1.25 mm and a width 42 of about 0.50 mm. The pads 12 may be arranged in any of a wide variety of configurations, again depending on the particular application. Consequently, the present invention should not be regarded as limited to pads 12 provided in any particular arrangement or configuration. However, by way of example, in the embodiment shown and described herein, the pads 12 are arranged in a generally square configuration, as best seen in FIG. 1.

The pitch or spacing 43 between adjacent pads 12 may be selected in accordance with the teachings provided herein, recognizing that the present invention will allow pad spacings 43 that are considerably less than the pad spacings possible with prior art soldering processes and solderable structures. In the embodiment shown and described herein, the pitch or spacing 43 between adjacent pads 12 is about 0.30 mm.

Referring now primarily to FIG. 3, each pad 12 may comprise a multi-layer structure having a base layer 44 and a top layer 46, although such a multi-layer pad structure is not required. The base and top layers 44 and 46 may comprise any of a wide range of metals and/or metal alloys suitable for the intended application. Consequently, the present invention should not be regarded as limited to pads comprising any particular configuration and made from any particular material. However, by way of example, in one embodiment, the base layer 44 of pad 12 comprises copper, whereas the top layer 46 comprises a nickel-gold alloy.

The thickness 34 of each pad 12 is not particularly critical, so long as the proper relationship between the thicknesses 34 and 36 of the pads 12 and 14, the first and second thicknesses 20 and 24 of the respective the solder mask layers 18 and 22, and the thickness 32 of solder 28 are selected in accordance with the teachings provided herein. Consequently, the present invention should not be regarded as limited to pads 12 having any particular thickness or range of thicknesses. However, by way of example, in one embodiment, the thickness 34 of each pad 12 is about 26 :m.

A solder mask layer 18 having a first thickness 20 (FIG. 3) is deposited on the first substrate 10 so that the solder mask layer 18 leaves exposed the pads 12 provided on the first substrate 10. More specifically, in the embodiment shown and described herein, the solder mask layer 18 defines a plurality of rectangularly-shaped openings 48 that completely surround or encircle the pads 12. However, it should be noted that it is not necessary for the solder mask layer 18 to completely surround the pads 12. For example, in another embodiment, the solder mask layer 18 may contain breaks or openings therein (not shown) around those portions of the pads 12 wherein some leakage or flow of liquid solder could be tolerated. However, in most applications, it will be generally advantageous to form the solder mask layer 18 so that it completely surrounds the solder pads 12.

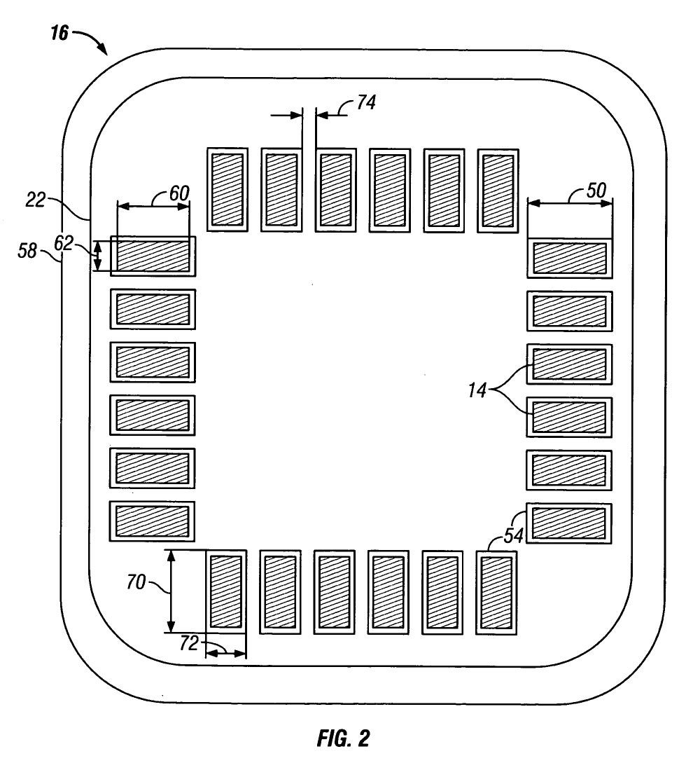

Referring again now to FIG. 1, the openings 48 defined by the solder mask layer 18 are generally aligned with the pads 12. In the embodiment shown and described herein, wherein each pad 12 comprises a generally rectangularly-shaped structure, each opening 48 also comprises a generally rectangularly-shaped structure having a length 50 and a width 52. Each opening 48 defined by the solder mask layer 18 is made to be slightly larger than the size of the pad 12 that is exposed thereby. That is, the length 50 and width 52 of the opening 48 should be selected so that they are slightly greater than the length 40 and width 42 of the corresponding pad 12. As will be described in greater detail below, by forming the opening 48 so that it is slightly larger than the size of the pad 12, the opening 48, together with a corresponding opening 54 (FIG. 2) provided in the solder mask layer 22 on the second substrate 16, will form a solder well 30, the volume of which is bounded by the solder wall 26. Generally speaking, good results can be achieved if the opening 48 in the solder mask layer 18 is about 0.05 mm larger (on each side) than the pad 12. Accordingly, in the embodiment shown and described herein, wherein the length 40 of each pad 12 is about 1.25 mm, the length 50 of each opening 48 is about 1.35 mm. Similarly, wherein the width 42 of each pad 12 is about 0.50 mm, the width 52 of each opening 48 is about 0.60 mm. The spacing 56 between the openings is about 0.20 mm.

Referring now to FIGS. 3 and 4, in one embodiment the thickness 20 of the solder mask layer 18 is selected so that it is greater than the thickness 34 of the pad 12. So selecting the thickness 20 of the solder mask layer 18 will allow the formation of the solder wall 26 (and resulting solder well 30) around the pads 12 and 14 when the first and second substrates 10 and 16 are positioned together. Alternatively, and as will be described in greater detail below, the formation of the solder wall 26 (and resulting solder well 30) may be accomplished by other variations to the thicknesses of the solder mask layers 18 and 22. By way of example, in the embodiment shown and described herein, the thickness 20 of the solder mask layer 18 is selected so that it is about 20 :m greater than the thickness 34 of the pad 12. Thus, in one embodiment wherein the thickness 34 of the pad 12 is about 26 :m, the thickness 20 of the solder mask layer 18 is about 48 :m.

The solder mask layer 18 may comprise any of a wide variety of solder mask materials deposited in accordance with any of a wide variety of processes that are known in the art or that may be developed in the future. Materials that may be used to form the solder mask layer 18 include any of a wide variety of liquid photo-imageable solder masks (LPISM), photo-imageable coverlays (PIC) or any of a wide range of epoxies which upon hardening will be capable of withstanding temperatures involved in manufacturing or subsequent service. LPISMs and PICs having thicknesses in the range of about 50 Fm to about 100 Fm are useful in that they typically can tolerate the temperature fluctuations associated with device manufacture. Consequently, the present invention should not be regarded as limited to any particular solder mask composition deposited in accordance with any particular method. However, by way of example, in one embodiment, the solder mask 18 may comprise any of a wide variety of a liquid photo-imageable solder mask (LPISM) materials that are well-known in the art and readily commercially available. Because such liquid photo-imageable solder masks are well-known in the art and could be readily provided by persons having ordinary skill in the art after having become familiar with the teachings provided herein, the particular solder mask material that may be used to form the solder mask layer 18, as well the method for depositing such solder mask material, will not be described in greater detail herein.

With reference now primarily to FIGS. 2 and 3, a second substrate 16 of a solderable structure that may be provided in accordance with the teachings provided herein may comprise at least one, and typically a plurality, of solder pads 14 provided thereon. The second substrate 16 may comprise any of a wide variety of substrates (e.g., rigid or flexible printed circuit boards) now known in the art or that may be developed in the future. Consequently, the present invention should not be regarded as limited to a second substrate 16 having any particular structure or made from any particular material. However, by way of example, in one embodiment, the second substrate 16 comprises a flexible printed wiring board 58 of conventional (e.g., polyamid) construction. Because the second substrate 16 could comprise any of a wide range of substrates and because a detailed description of the particular structure and materials that may comprise the second substrate 16 is not necessary to practice the present invention, the particular substrate 16 that may be utilized in one embodiment of the present invention will not be described in further detail herein.

Referring now primarily to FIG. 2, the various solder pads 14 provided on the second substrate 16 are electrically connected to circuit traces (not shown) that may be provided on or within the second substrate 16 by conventional means. In the embodiment shown and described herein, each pad 14 comprises a generally rectangularly shaped structure having a length 60, a width 62, and a thickness 36 (FIG. 3). The particular configuration and dimensions of the solder pads 14 provided on the second substrate 16 are not particularly critical, so long as they are compatible with the pads 12 provided on the first substrate 10. By way of example, in one embodiment, each pad 14 is slightly smaller than the corresponding pad 12 and comprises a rectangular configuration having a length 60 of about 1.15 mm and a width 62 of about 0.40 mm. The pitch or spacing 64 between adjacent pads 14 may be selected to be compatible with the pitch or spacing 43 between the pads 12 on the first substrate 10. In the embodiment shown and described herein, the pitch or spacing 64 between adjacent pads 14 is about 0.35 mm.

Referring now primarily to FIG. 3, each pad 14 may comprise a multi-layer structure having a base layer 66 and a top layer 68, although such a multi-layer pad structure is not required. The base and top layers 66 and 68 may comprise any of a wide range of metals and/or metal alloys suitable for the intended application. Consequently, the present invention should not be regarded as limited to pads 14 comprising any particular configuration and made from any particular material. However, by way of example, in one embodiment, the base layer 66 of pad 14 comprises copper, whereas the top layer 68 comprises a nickel-gold alloy.

The thickness 36 of each pad 14 is not particularly critical, so long as the proper relationship between the thicknesses 34 and 36 of the pads 12 and 14, the thicknesses 20 and 24 of the solder mask layers 18 and 22, and the thickness 32 of the solder 28 are selected in accordance with the teachings provided herein. Consequently, the present invention should not be regarded as limited to pads 14 having any particular thickness or range of thicknesses. However, by way of example, in one embodiment, the thickness 36 of each pad 14 is about 26 :m.

A solder mask layer 22 having a second thickness 24 (FIG. 3) is deposited on the second substrate 16 so that the solder mask layer 22 leaves exposed the pads 14 provided on the second substrate 16. More specifically, in the embodiment shown and described herein, the solder mask layer 22 defines a plurality of rectangularly-shaped openings 54 that completely surround or encircle the pads 14. See FIG. 2. However, and as was the case for the openings 48 in the solder mask layer 18 on the first substrate 10, it should be noted that it is not necessary for the solder mask layer 22 to completely surround the pads 14. For example, in another embodiment, the solder mask layer 22 may contain breaks or openings therein (not shown) around those portions of the pads 14 wherein some leakage or flow of liquid solder could be tolerated. However, in most applications, it will be generally advantageous to form the solder mask layer 22 so that it completely surrounds the solder pads 14.

Referring again now to FIG. 2, the openings 54 defined by the solder mask layer 22 are generally aligned with the pads 14 so the pads 14 remain exposed. In the embodiment shown and described herein, wherein each pad 14 comprises a generally rectangularly-shaped structure, each opening 54 in the solder mask layer 22 also comprises a generally rectangularly-shaped structure having a length 70 and a width 72. Each opening 54 in the solder mask layer 22 is made to be slightly larger than the size of the corresponding pad 14, i.e., so that the length 70 and width 72 of the opening 54 are slightly greater than the length 60 and width 62 of the corresponding pad 14. By forming the opening 54 so that it is slightly larger than the size of the pad 14, the opening 54, together with the corresponding opening 48 (FIG. 1) provided in the solder mask layer 18 on the first substrate 10 will form the solder wall 26 and resulting solder well 30. See FIG. 4. Generally speaking, good results can be achieved if the opening 54 in the solder mask layer 22 is about 0.05 mm larger (on each side) than the pad 14. Accordingly, in the embodiment shown and described herein, the length 70 of each opening 54 is about 1.25 mm, whereas the width 72 of each opening 54 is about 0.55 mm. The spacing 74 between the openings 54 is about 0.25 mm.

Referring now to FIG. 3, in one embodiment the thickness 24 of the solder mask layer 22 is selected so that it is greater than the thickness 36 of the pad 14. So selecting the thickness 24 of the solder mask layer 22 will allow the solder well 30 (FIG. 4) to be formed around the pads 12 and 14 when the first and second substrates 10 and 16 are positioned together. By way of example, in the embodiment shown and described herein, the thickness 24 of the solder mask layer 22 is selected so that it is about 20 :m thicker than the thickness 36 of the pad 14. Thus, in one embodiment wherein the thickness 36 of the pad 14 is about 26 :m, the thickness 24 of the solder mask layer 22 is about 52 :m.

As mentioned above, the thicknesses 20 and 24 of the respective solder mask layers 18 and 22 may comprise any of a wide range of thicknesses, so long as the sum of the thicknesses 20 and 24 of the solder mask layers 18 and 22 is at least as great as the sum of the thicknesses 34 and 36 of the pads 12 and 14. So selecting the thicknesses will cause the solder mask layers 18 and 22 too contact one another and define the solder mask wall 26, and resulting solder well 30, when the first and second substrates 10 and 16 are positioned adjacent one another so that the respective pads 12 and 14 provided thereon are in the desired alignment. See FIG. 4.

As was the case for the solder mask layer 18 provided on the first substrate 10, the solder mask layer 22 provided on the second substrate 16 may comprise any of a wide variety of solder mask materials deposited in accordance with any of a wide variety of processes that are known in the art or that may be developed in the future. Consequently, the present invention should not be regarded as limited to any particular solder mask composition deposited in accordance with any particular method. However, by way of example, in one embodiment, the solder mask 22 comprises the same liquid photo-imageable solder mask (LPISM) material that was used to form the solder mask layer 18. However, because such liquid photo-imageable solder masks are well-known in the art and could be readily provided by persons having ordinary skill in the art after having become familiar with the teachings provided herein, the particular solder mask material that may be used to form the solder mask layer 22, as well the method for depositing such solder mask material, will not be described in greater detail herein.

Before the pads 12 and 14 on the respective first and second substrates 10 and 16 can be soldered together, solder 28 is provided to either one or both of the pads 12 and 14. For example, in the embodiment shown and described herein, solder 28 is provided to the pads 14 provided on the second substrate 16. As mentioned above, the amount (e.g., volume) of solder 28 provided to the pads (e.g., pads 14) should not exceed the volume of the solder well 30 defined by the solder mask wall 26 when the first and second substrates 10 and 16 are positioned in contact with one another. See FIG. 4. It is also generally preferred that the solder 28 be provided in a thickness 32 so that the sum of the thickness 32 of the solder 28 together with the respective thicknesses 34 and 36 of pads 12 and 14 exceeds the sum of the first and second thicknesses 20 and 24 of the respective solder mask layers 18 and 22. So selecting the thicknesses will allow the solder 28 provided to the pads (e.g., pads 14) to contact the corresponding mating pads (e.g., pads 12) before the solder mask layers 18 and 22 contact one another, thereby ensuring positive bonding between the solder 28 and the pads 12 and 14. Stated another way, the presence of the solder mask layers 18 and 22 on the substrates 10 and 16 limits the compression (i.e., distance) between the solder pads 12 and 14 provided on the substrates 10 and 18, thus creating a predetermined gap between the pads 12 and 14 for the proper volume of solder 28 to be filled-in during soldering.

The solder 28 may comprise any of a wide range of alloys suitable for the particular application. Examples of solders include, but are not limited to high temperature solders, low temperature solders, and lead-free solders. Consequently, the present invention should not be regarded as limited to any particular type of solder or solder alloy. However, by way of example, in one embodiment, the solder 28 comprises a tin-lead alloy. The solder 28 may be provided to the pads (e.g., pads 14) by any convenient method, such as, for example, by applying solder paste in the appropriate quantity (i.e., volume) in accordance with the teachings provided herein. After being applied to the pads (e.g., pad 14), the solder paste may be melted, if desired, to cause the solder 28 to re-form into a semi-spherical configuration having a thickness 32 in accordance with the teachings provided herein. See FIG. 3. However, since solder pastes and methods for providing solder pastes are well-known in the art and could be easily provided by persons having ordinary skill in the art after having become familiar with the teachings provided herein, the particular solder paste and method for applying the solder paste that may be utilized in one embodiment of the invention will not be described in further detail herein.

After the appropriate amount of solder 28 has been provided to the pads (e.g., pads 14), the two substrates 10 and 16 are positioned adjacent one another so that the pads 12 and 14 provided thereon are in the desired alignment, as best seen in FIG. 3. Further moving together the two substrates 10 and 16 will cause the solder 28 provided on pads 14 to contact the corresponding pads 12. The solder 28 may then be re-flowed (e.g., melted) by appropriate soldering apparatus (not shown). For example, in one embodiment, a hot bar or thermode (not shown) of a hot bar soldering apparatus (not shown) may be brought into contact with the back side 76 (FIG. 4) of the second substrate 16. After sufficient heat has been applied, the solder 28 will melt or re-flow to form a conductive bond between the pads 12 and 14. See FIG. 4. The solder mask wall 26 formed by the contacting abutment of the solder mask layers 18 and 22 prevents liquid solder from flowing beyond the solder mask wall 26.

Having herein set forth preferred embodiments of the present invention, it is anticipated that suitable modifications can be made thereto which will nonetheless remain within the scope of the invention. The invention shall therefore only be construed in accordance with the following claims:

1. A process for soldering a pad on a first substrate to a pad on a second substrate, comprising:
coating the first substrate with a solder mask having a first thickness so that the solder mask leaves exposed the pad on the first substrate;
coating the second substrate with a solder mask having a second thickness so that the solder mask leaves exposed the pad on the second substrate, the first and second thicknesses of the solder masks being selected so that the solder masks on the first and second substrates contact one another and define a solder mask wall when the first and second substrates are positioned adjacent one another so that the pads are substantially aligned;
providing solder to at least one of the pads;
placing the first and second substrates adjacent one another so that the pads are substantially aligned; and
re-flowing the solder to join the pads, the solder mask wall preventing liquid solder from flowing beyond the solder mask wall.

2. The process of claim 1, wherein coating the first substrate with a solder mask having a first thickness comprises coating the first substrate with a solder mask having a first thickness that is greater than a thickness of the pad on the first substrate.

3. The process of claim 1, wherein coating the second substrate with a solder mask having a second thickness comprises coating the second substrate with a solder mask having a second thickness that is greater than a thickness of the pad on the second substrate.

4. The process of claim 1, wherein coating the first substrate with a solder mask comprises coating the first substrate with a solder mask defining an opening therein that is generally aligned with the pad on the first substrate, an area of the opening defined by the solder mask being greater than an area of the pad on the first substrate.

5. The process of claim 1, wherein coating the second substrate with a solder mask comprises coating the second substrate with a solder mask defining an opening therein that is generally aligned with the pad on the second substrate, an area of the opening defined by the solder mask being greater than an area of the pad on the second substrate.

6. The process of claim 1, wherein the solder mask wall substantially surrounds the pads on the first and second substrates when the first and second substrates are positioned adjacent one another so that the pads are substantially aligned, the solder mask wall enclosing a volume adjacent the pads on the first and second substrates, and wherein providing solder to at least one of the pads comprises providing a volume of solder to at least one of the pads, the volume of solder being less than the volume enclosed by the solder mask wall.

7. The process of claim 1, wherein providing solder to at least one of the pads comprises providing solder having a thickness to the pad on the first substrate, the thickness of the solder being greater than the first thickness of the solder mask on the first substrate.

8. The process of claim 1, wherein providing solder to at least one of the pads comprises providing solder having a thickness to the pad on the second substrate, the thickness of the solder being greater than the second thickness of the solder mask on the second substrate.

9. The process of claim 1, wherein providing solder to at least one of the pads comprises:
providing solder having a first thickness to the pad on the first substrate; and
providing solder having a second thickness to the pad on the second substrate, the sum of the first and second thicknesses of the solder together with the thicknesses of the pads exceeding the sum of the first and second thicknesses of the solder masks.

10. The process of claim 1, wherein re-flowing the solder comprises contacting a hot bar soldering apparatus to the first substrate.

11. The process of claim 1, wherein re-flowing the solder comprises contacting a hot bar soldering apparatus to the second substrate.

12. The process of claim 1, wherein coating the first substrate with a solder mask comprises coating the first substrate with a liquid photo-imageable solder mask and wherein coating the second substrate with a solder mask comprises coating the first substrate with a liquid photo-imageable solder mask.

13. A process for soldering a pad on a first substrate to a pad on a second substrate, comprising:
coating the first substrate with a solder mask having a first thickness, the solder mask defining an opening therein that exposes the pad on the first substrate;
coating the second substrate with a solder mask having a second thickness, the solder mask defining an opening therein that exposes the pad on the second substrate, the first and second thicknesses of the solder masks being selected so that the solder masks on the first and second substrates contact one another and define a solder mask wall that substantially encloses the pads on the first and second substrates when the first and second substrates are positioned adjacent one another so that the pads are substantially aligned;
providing solder to at least one of the pads;
placing the first and second substrates adjacent one another so that the pads are substantially aligned; and
melting the solder to join the pads, the solder mask wall enclosing the pads preventing liquid solder from flowing beyond the solder mask wall.

14. The process of claim 13, wherein the opening defined by the solder mask on the first substrate has an area that is greater than the area of the pad on the first substrate and wherein the opening defined by the solder mask on the second substrate has an area that is greater than the area of the pad on the second substrate.

15. The process of claim 13, wherein providing solder to at least one of the pads comprises providing solder having a thickness to the pad on the first substrate, the thickness of the solder being greater than the first thickness of the solder mask on the first substrate.

16. The process of claim 13, wherein providing solder to at least one of the pads comprises providing solder having a thickness to the pad on the second substrate, the thickness of the solder being greater than the second thickness of the solder mask on the second substrate.

17. The process of claim 13, wherein providing solder to at least one of the pads comprises:
providing solder having a first thickness to the pad on the first substrate; and
providing solder having a second thickness to the pad on the second substrate, the sum of the first and second thicknesses of the solder together with the thicknesses of the pads exceeding the sum of the first and second thicknesses of the solder masks.

18. Apparatus, comprising:
a first substrate having at least one pad thereon, the at least one pad having a thickness, the first substrate having a solder mask layer deposited thereon, the solder mask layer having a first thickness and defining an opening therein, the opening in the solder mask layer being substantially aligned with the at least one pad so that the at least one pad is exposed by the solder mask layer; and
a second substrate having at least one pad thereon, the at least one pad having a thickness, the second substrate having a solder mask layer deposited therein, the solder mask layer having a second thickness and defining an opening therein, the opening in the solder mask layer being substantially aligned with the at least one pad so that the at least one pad is exposed by the solder mask layer.

19. The apparatus of claim 18, wherein the first and second thicknesses of the solder mask layers on said first and second substrates together exceed the combined thicknesses of the pads on said first and second substrates, so that the solder mask layers on said first and second substrates contact one another and define a solder mask wall that substantially encloses the pads on the first and second substrates when the first and second substrates are positioned adjacent one another so that the pads are substantially aligned.

20. The apparatus of claim 18, further comprising solder deposited to a thickness on the pad on said first substrate, the thickness of the solder being greater than the first thickness of the solder mask layer provided on said first substrate.

21. The apparatus of claim 18, further comprising solder deposited to a thickness on the pad on said second substrate, the thickness of the solder being greater than the second thickness of the solder mask layer provided on said second substrate.
